(19) United States
(12) Patent Application Publication
(10) Pub. No.: US 2016/0239211 A1
(43) Pub. Date: Aug. 18, 2016

(54) PROGRAMMING MEMORY CONTROLLERS TO ALLOW PERFORMANCE OF ACTIVE MEMORY OPERATIONS

(71) Applicant: HEWLETT PACKARD ENTERPRISE DEVELOPMENT LP, Houston, TX (US)

(72) Inventors: Kevin T. Lim, Palo Alto, CA (US); Naveen Muralimanohar, Palo Alto, CA (US)

(21) Appl. No.: 15/025,616

(22) PCT Filed: Sep. 30, 2013
(86) PCT No.: PCT/US2013/062667

§ 371 Date: Mar. 29, 2016

(51) Int. Cl. G06F 3/06

(52) U.S. Cl. CPC G06F 3/0605; G06F 3/0613; G06F 3/0659; G06F 3/0673

(57) ABSTRACT

Example implementations relate to performing active memory operations. In example implementations, a memory controller may be programmed such that the memory controller allocates more time for a standard memory operation than required by a timing specification of a memory communicatively coupled to the memory controller. Extra time that is allocated for the standard memory operation may be identified. An active memory operation may be performed during the extra time.

### BACKGROUND

Memory controllers may be used to control access to memories, and may, for volatile memories, control when data bits in the memories are refreshed. When data in a volatile memory in a system is being refreshed, the memory may be temporarily unavailable to other components of the system. A timing specification of the memory may define various timing parameters used to determine how long refresh cycles take and how often they should occur, as well as how much time is required to perform read and write operations on the memory.

### BRIEF DESCRIPTION OF THE DRAWINGS

The following detailed description references the drawings, wherein:

FIG. 1 is a block diagram of an example memory module in communication with an example memory controller to enable performance of active memory operations;

FIG. 2 is a block diagram of an example memory module in communication with an example memory controller to enable selections of active memory operations;

FIG. 3 is a block diagram of an example memory module in communication with an example memory controller to enable programming of registers for allowing active memory operations to be performed;

FIG. 4 is a block diagram of an example memory module in communication with an example memory controller to enable selection of active memory operations and control over access to data in a volatile memory;

FIG. 5 is a flowchart of an example method for performing active memory operations;

FIG. 6 is a flowchart of an example method for programming registers to allow active memory operations to be performed and selecting active memory operations;

FIG. 7 is a flowchart of an example method for determining when an active memory operation should be performed;

FIG. 8 is a flowchart of an example method for allowing a selected active memory operation to be performed; and

FIG. 9 is a flowchart of an example method for allocating time to perform active memory operations.

### DETAILED DESCRIPTION

A main memory controller in a system may send requests to a volatile memory to perform various operations, such as reading, writing, or refreshing data. A main memory controller may be programmed with timing constraints, according to which the memory controller may wait for certain amounts of time for the volatile memory to respond to respective types of requests. If the volatile memory violates a timing constraint (e.g. does not respond to a particular request within an allocated time period), a system crash may occur, and/or the main memory controller may consider the volatile memory to be corrupted or dead.

An active memory may be tightly coupled to a volatile memory to allow certain operations, such as filtering, to occur in close physical proximity to the volatile memory. Because of its proximity to the volatile memory, an active memory may operate with higher bandwidth and lower latency than an external processor, and may have access to places the external processor cannot access. The active memory may temporarily utilize the volatile memory to perform certain operations, during which the volatile memory may be unavailable to respond to requests from an external main memory controller. Because timing constraints of a main memory controller tend to be tight, an active memory may not be able to utilize the volatile memory and perform, for example, a filtering operation without violating a timing constraint of the external main memory controller.

In light of the above, the present disclosure provides for programming a main memory controller to allow time for an active memory to perform, for example, a filtering operation without violating timing constraints of the main memory controller. A memory controller may be programmed such that after the memory controller sends a read/write/refresh request to a volatile memory, the length of time the memory controller waits for a response is long enough for the read/write/refresh operation to be performed as well as for an active memory to perform an additional operation. An active memory may select an additional operation to perform based on how much extra time is left after the read/write/refresh operation is completed.

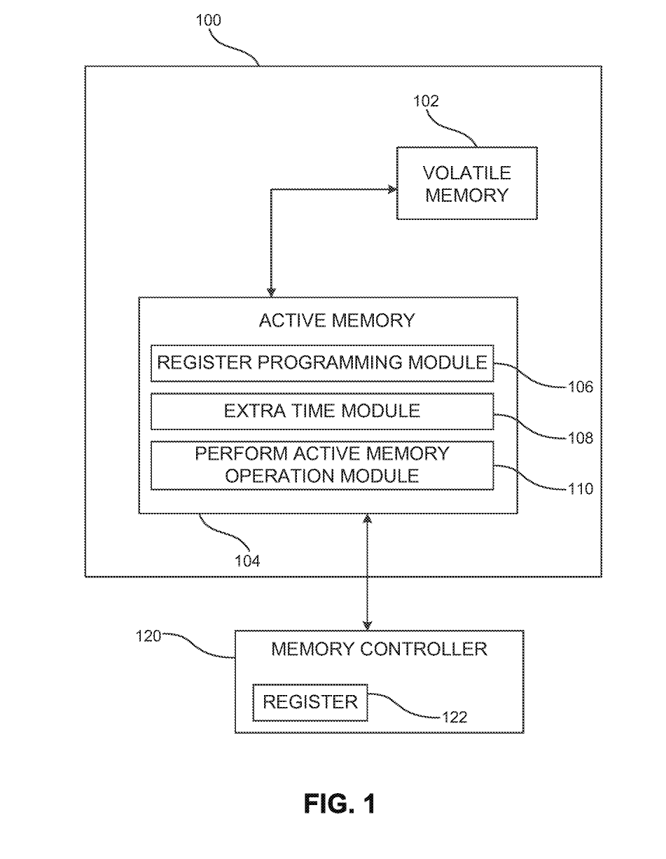

Referring now to the drawings, FIG. 1 is a block diagram of an example memory module 100 in communication with an example memory controller 120 to enable performance of active memory operations. Memory module 100 may be an in-line memory module, such as a single in-line memory module (SIMM) or a dual in-line memory module (DIMM), or any memory module suitable for mounting volatile memory integrated circuits (ICs). In FIG. 1, memory module 100 includes volatile memory 102 and active memory 104.

Volatile memory 102 may include random access memory (RAM), such as dynamic random access memory (DRAM), in the form of an IC. Volatile memory 102 may contain or store executable instructions and/or data for analysis by a processor. Data may be written to and read from volatile memory 102, and data bits stored in volatile memory 102 may be periodically refreshed to avoid data loss. The term “refresh” as used herein refers to a maintenance operation during which data in memory cells of a volatile memory are read and rewritten to the respective memory cells. A length of time during which a refresh operation is performed may be referred to herein as a refresh cycle. Read, write, and refresh operations performed with respect to a memory may be collectively referred to herein as standard memory operations. The term “standard memory operation” as used herein may refer to any of a read, write, and refresh operation. A timing specification of volatile memory 102 may specify how much time is required to perform standard memory operations on volatile memory 102 (e.g., number of clock cycles between volatile memory 102 receiving a read command and outputting data).

A command to perform a standard memory operation may be transmitted to memory module 100 from memory controller 120. Memory controller 120 may be communicatively coupled to volatile memory 102 through active memory 104. Memory controller 120 may be communicatively coupled to memory module 100 via a data bus, such as a double data rate type three (DDR3) bus. The data bus type and/or speed may correspond to a memory type/operating speed of volatile memory 102. Memory controller 120 may be a digital circuit that is integrated into a processor external to memory module 100, or on a separate IC. Memory controller 120 may control when components external to memory module 100 are able to access volatile memory 102, and may manage the flow of data going to and from volatile memory 102. For example, when data bits in volatile memory 102 are being refreshed. memory controller 120 may suspend requests from external components to access volatile memory 102.

Memory controller 120 may include register 122, which may be associated with a time allocated for a standard memory operation. Register 122 may be programmed with a value used to determine how much time is allocated for a standard memory operation. For example, register 122 may be programmed with a value used to determine how much time is allocated for a refresh cycle to occur in volatile memory 102. It should be understood that memory controller 120 may have more registers in addition to register 122, and that the additional registers may be associated with the same standard memory operation or different standard memory operations. In some implementations, volatile memory 102 may include multiple memory types; the additional registers may be used to determine a time allocated for a standard memory operation for the same memory type or a different memory type as that for which the value in register 122 is used.

The amount of time allocated for a standard memory operation may be greater than the amount of time that a timing specification of volatile memory 102 requires for the standard memory operation. The difference between the amount of time allocated for a standard memory operation and the amount of time a timing specification requires for the standard memory operation may be referred to herein as “extra time”. During extra time, active memory 104 may perform an operation other than a standard memory operation using data from volatile memory 102. Non-standard memory operations may include filtering, searching, compressing, and/or transferring data, and may be collectively referred to herein as active memory operations. The term “active memory operation” as used herein may refer to any operation, other than a read, write, or refresh operation, performed by an active memory on a memory module.

Active memory 104 may be communicatively coupled to volatile memory 102 on memory module 100 and to memory controller 120. Active memory 104 may include a processor-in-memory, field programmable gate array (FPGA), and/or logic core, and may be tightly coupled to volatile memory 102. Active memory 104 may include a buffer for storing data read from volatile memory 102, and may process the data in the buffer while standard memory operations are performed on volatile memory 102. Active memory 104 may read data from volatile memory 102 into the buffer and perform an active memory operation using the data. An active memory may also be referred to herein as an enhanced buffer. Active memory 104 may transmit data read from volatile memory 102 to memory controller 120 or to another component external to memory module 100.

As illustrated in FIG. 1 and described in detail below, active memory 104 may include modules 106, 108, and 110. A module may include a set of instructions encoded on a machine-readable storage medium and executable by a processor of active memory 104. In addition or as an alternative, a module may include a hardware device comprising electronic circuitry for implementing the functionality described below.

Register programming module 106 may cause memory controller 120 to be programmed such that memory controller 120 allocates more time for a standard memory operation than required by a timing specification of volatile memory 102. For example, a timing specification of volatile memory 102 may require a first length of time for a refresh cycle to be completed in volatile memory 102, and register programming module 106 may cause memory controller 120 to be programmed such that memory controller 120 allocates a second length of time that is longer than the first length of time for a refresh cycle. As another example, a timing specification of volatile memory 102 may require a first length of time between refresh operations (e.g., the timing specification may require that a refresh cycle occur every 7.5 microseconds), and register programming module 106 may cause memory controller 120 to be programmed such that after each refresh cycle is complete, memory controller 120 transmits another refresh command to volatile memory 102 after a second length of time (e.g., 5 microseconds) shorter than the first length of time. That is, memory controller 120 may be programmed such that refresh commands are transmitted more frequently than required by a timing specification of volatile memory 102. It should be understood that register programming module 106 may cause memory controller 120 to be programmed to allocate more time for other types of standard memory operations other than refresh operations. For example, memory controller 120 may be programmed to allow longer read/write latency times than required by a timing specification of volatile memory 102.

In some implementations, register programming module 106 may determine a value to be programmed into a programmable register, such as register 122, of memory controller 120. For example, if the value in a programmable register corresponds to how many clock cycles are allocated for a refresh cycle, and a timing specification of volatile memory 102 specifies a length of time required for a refresh cycle to be completed, register programming module 106 may calculate, based on an operating frequency of memory controller 120, how many clock cycles occur during the specified length of time. Register programming module 106 may then select a value greater than the calculated number of clock cycles to be programmed into the programmable register. In some implementations, register programming module 106 may read latency times of a timing specification stored in a non-volatile memory (e.g., a serial presence detect ROM or electrically erasable programmable read-only memory) on memory module 100, and may use the latency times to calculate a value to be programmed into a programmable register such that more time is allocated for a standard memory operation.

Register programming module 106 may cause memory controller 120 to be programmed during boot time of memory controller 120 or during run time of memory controller 120. In some implementations, register programming module 106 may communicate with a Basic Input/Output System (BIOS) to cause memory controller 120 to be programmed. The BIOS may include machine-readable instructions (e.g., low-level software) stored within server hardware. The BIOS may control initializing and programming the configuration of hardware components to enable them to operate together. The BIOS may have information about latency values of memory module 100, volatile memory 102, and any other volatile memories on memory module 100. During a boot process of memory controller 120, the BIOS may feed the latency values to registers in memory controller 120 through software application programming interfaces (APIs). In some implementations, register programming module 106 may modify the latency values in the BIOS (e.g., by flashing the BIOS) or send different latency values to the BIOS, and the BIOS may update registers in memory controller 120 with the modified/different latency values, which may increase the amount of time allocated for standard operations. The BIOS may update the registers during runtime of memory controller 120 or during the next boot time of memory controller 120.

Extra time module 108 may identify extra time allocated for a standard memory operation. In some implementations, extra time module 108 may identify a standard memory operation to be performed on volatile memory 102 and determine how long a timing specification of volatile memory 102 requires for the identified standard memory operation. Extra time module 108 may determine how much time memory controller 120 has allocated for the standard memory operation (e.g., by reading a value stored in register 122), and may subtract the required time from the allocated time to determine how much extra time is allocated for the standard memory operation. In some implementations, extra time module 108 may detect a command transmitted by memory controller 120 to perform a standard memory operation on volatile memory 102, determine how much time memory controller 120 has allocated for the standard memory operation, and monitor progress in performing the standard memory operation. Extra time module 108 may indicate that extra time has been allocated for the standard memory operation if the standard memory operation is completed before the allocated time has fully elapsed.

Perform active memory operation module 110 may perform an active memory operation during extra time allocated for a standard memory operation. For example, perform active memory operation module 110 may filter data in a buffer of active memory 104 (e.g., perform a text search on data in the buffer to identify data relevant to a specified criterion), compress data in the buffer, move data to the buffer from within active memory 104, and/or access a node within a data structure (e.g., red-black tree) stored within memory module 100. In some implementations, perform active memory operation module 110 may perform an active memory operation after detecting an indication from extra time module 108 that extra time has been allocated for a standard memory operation.

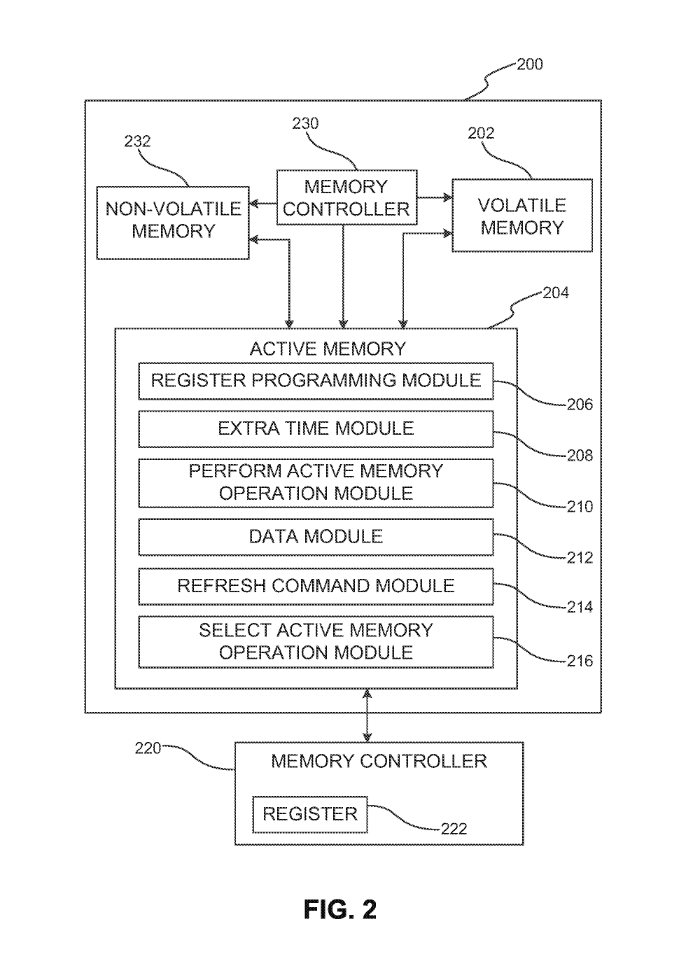

FIG. 2 is a block diagram of an example memory module 200 in communication with an example memory controller 220 to enable selections of active memory operations. Memory module 200 may be an in-line memory module, such as a SIMM or DIMM, or any memory module suitable for mounting volatile memory ICs. In FIG. 2, memory module 200 includes volatile memory 202, active memory 204, memory controller 230, and non-volatile memory 232.

Volatile memory 202 may be analogous to (e.g., have functions and/or components similar to) volatile memory 102. A timing specification of volatile memory 202 may specify how much time is required to perform standard memory operations on volatile memory 202. A command to perform a standard memory operation may be transmitted to memory module 200 from memory controller 220, which may include register 222. Memory controller 220 and register 222 may be analogous to memory controller 120 and register 122, respectively. Memory controller 220 may be communicatively coupled to memory module 200 via a data bus, such as a DDR3 bus. The data bus type and/or speed may correspond to a memory type/operating speed of volatile memory 202.

It should be understood that memory controller 220 may have more registers in addition to register 222, and that the additional registers may be associated with the same standard memory operation as or different standard memory operations than that associated with register 222. In some implementations, volatile memory 202 may include multiple memory types; the additional registers may be used to determine a time allocated for a standard memory operation for the same memory type or a different memory type as that for which the value in register 222 is used. The amount of time allocated for a standard memory operation may be greater than the amount of time that a timing specification of volatile memory 202 requires for the standard memory operation. During the extra time, active memory 204 may perform an active memory operation.

Active memory 204 may be communicatively coupled to volatile memory 202, non-volatile memory 232, and memory controller 230 on memory module 200, and to memory controller 220. Non-volatile memory 232 may include an electrically erasable programmable read-only memory (EEPROM), a flash memory, and/or other memory that retains stored data even when not powered. Memory controller 230 may be an internal memory controller on memory module 200, and may be a digital circuit that controls access by active memory 204 and other components within memory module 200 to volatile memory 202 and non-volatile memory 232. Memory controller 230 may manage the flow of data between volatile memory 202, non-volatile memory 232, and other components within memory module 200. Although memory controller 230 is shown separately from active memory 204 in FIG. 2, it should be understood that in some implementations, memory controller 230 may be integrated into active memory 204.

Active memory 204 may include a processor-in-memory, FPGA, and/or logic core, and may be tightly coupled to volatile memory 202. Active memory 204 may include a buffer for storing data read from volatile memory 202 and/or non-volatile memory 232, and may process the data in the buffer while standard memory operations are performed on volatile memory 202. As illustrated in FIG. 2 and described in detail below, active memory 204 may include modules 206, 208, 210, 212, 214, and 216. A module may include a set of instructions encoded on a machine-readable storage medium and executable by a processor of active memory 204. In addition or as an alternative, a module may include a hardware device comprising electronic circuitry for implementing the functionality described below.

Modules 206, 208, and 210 of active memory 204 may be analogous to modules 106, 108, and 110 of active memory 104. Data module 212 may read data from and write data to volatile memory 202 and/or non-volatile memory 232, and may transfer data between volatile memory 202 and non-volatile memory 232. For example, data module 212 may read data from non-volatile memory 232 into a buffer on active memory 204, and may write the data in the buffer to volatile memory 202. In some implementations, data module 212 may transmit data read from volatile memory 202 and/or non-volatile memory 232 to memory controller 220 or to another component external to memory module 200.

Refresh command module 214 may detect a refresh command issued by memory controller 220 and determine whether to execute the detected refresh command. Memory controller 220 may be programmed to transmit refresh commands more frequently than required by a timing specification of volatile memory 202, and thus data in volatile memory 202 may be retained even if a refresh cycle is not performed every time memory controller 220 issues a refresh command. When refresh command module 214 detects a refresh command issued by memory controller 220 to refresh a group of data bits of volatile memory 202, refresh command module 214 may determine how long ago the last refresh cycle was completed on the group of data hits. If the determined time is less than the maximum time between refresh cycles required by the timing specification of volatile memory 202, refresh command module 214 may determine that the detected refresh command should not be executed. If the detected refresh command is not executed, perform active memory operation module 210 may use the time that memory controller 220 has allocated for a refresh cycle to perform an active memory operation.

In some implementations, the frequency at which memory controller 220 issues refresh commands may be a multiple of the refresh frequency required by a timing specification of volatile memory 202. Refresh command module 214 may use a counter to determine when a detected refresh command should be executed. For example, memory controller 220 may be programmed to issue a refresh command four times as often as required by the timing specification of volatile memory 202. Refresh command module 214 may increment a counter every time a refresh command is detected, and may determine that a detected refresh command is to be executed when the counter value is a multiple of four. When the counter value is not a multiple of four, refresh command module 214 may determine that a detected refresh command is not to be executed.

In some implementations, extra time module 208 may determine how much extra time is allocated for a standard memory operation, as discussed above with respect to FIG. 1. Select active memory operation module 216 may select an active memory operation based on how much extra time is allocated. Select active memory operation module 216 may determine how long each of a plurality of active memory operations take to complete, and may select one of the plurality of active memory operations that takes less time than the amount of extra time allocated.

In some implementations, select active memory operation module 216 may select an active memory operation to be performed and determine how much time is required to perform the selected active memory operation. Register programming module 206 may cause memory controller 220 to be reprogrammed such that the time allocated by memory controller 220 for a standard memory operation is enough to perform the standard memory operation and the selected active memory operation. Register programming module 206 may calculate how much time the standard memory operation takes. then add the standard memory operation time to the selected active memory operation time to determine a value to program into a register of memory controller 220.

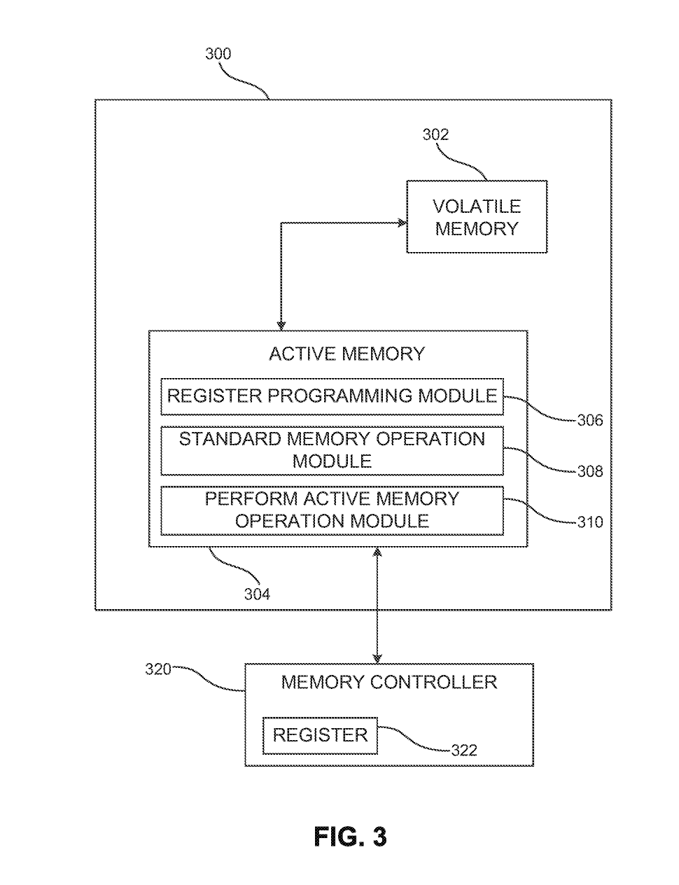

FIG. 3 is a block diagram of an example memory module 300 in communication with an example memory controller 320 to enable programming of registers for allowing active memory operations to be performed. Memory module 300 may be an in-line memory module, such as a SIMM or DIMM, or any memory module suitable for mounting volatile memory ICs. In FIG. 3, memory module 300 includes volatile memory 302 and active memory 304.

Volatile memory 302 may be analogous to volatile memory 102. A timing specification of volatile memory 302 may specify how much time is required to perform standard memory operations on volatile memory 302. A command to perform a standard memory operation may be transmitted to memory module 300 from memory controller 320, which may include register 322. Memory controller 320 and register 322 may be analogous to memory controller 120 and register 122, respectively. Memory controller 320 may be communicatively coupled to memory module 300 via a data bus. The data bus type and/or speed may correspond to a memory type/operating speed of volatile memory 302.

It should be understood that memory controller 320 may have more registers in addition to register 322, and that the additional registers may be associated with the same standard memory operation as or different standard memory operations than that associated with register 322. In some implementations, volatile memory 302 may include multiple memory types; the additional registers may be used to determine a time allocated for a standard memory operation for the same memory type or a different memory type as that for which the value in register 322 is used. The amount of time allocated for a standard memory operation may be greater than the amount of time that a timing specification of volatile memory 302 requires for the standard memory operation. During the extra time, active memory 304 may perform an active memory operation.

Active memory 304 may be communicatively coupled to volatile memory 302 on memory module 300 and to memory controller 320. Active memory 304 may include a processor-in-memory, FPGA, and/or logic core, and may be tightly coupled to volatile memory 302. Active memory 304 may include a buffer for storing data read from volatile memory 302, and may process the data in the buffer while standard memory operations are performed on volatile memory 302. Active memory 304 may transmit data read from volatile memory 302 to memory controller 320 or to another component external to memory module 300.

As illustrated in FIG. 3 and described in detail below, active memory 304 may include modules 306, 308, and 310. A module may include a set of instructions encoded on a machine-readable storage medium and executable by a processor of active memory 304. In addition or as an alternative, a module may include a hardware device comprising electronic circuitry for implementing the functionality described below.

Register programming module 306 may cause a register (e.g., register 322) of memory controller 320 to be programmed such that memory controller 320 allocates time, for a standard memory operation, based on operation of volatile memory 302 at a first frequency. In some implementations, register programming module 306 may detect a frequency at which volatile memory 302 is being operated; the detected frequency may be faster than the first frequency. For example, the detected frequency may be a frequency at which volatile memory 302 is operated during a normal-power or high-power mode, and the first frequency may be a frequency at which volatile memory 302 is operated during a power-saving mode. To obtain more time for active memory 304 to perform active memory operations, register programming module 306 may cause memory controller 320 to be programmed to allocate time for standard memory operations based on operation of volatile memory 302 at the first frequency rather than the detected operating frequency. Because volatile memory 302 may be operated at a frequency faster than the first frequency, a standard operation may be completed on volatile memory 302 in a length of time shorter than the allocated time for the standard memory operation, resulting in extra time for an active memory operation to be performed.

Standard memory operation module 308 may cause a standard memory operation to be performed on volatile memory 302 during time allocated for the standard memory operation. The time allocated for the standard memory operation may be based on operation of volatile memory 302 at a first frequency, as discussed above. During the allocated time, volatile memory 302 may be operated at a second frequency higher than the first frequency. Standard memory operation module 308 may detect and/or receive, from memory controller 320, commands to perform standard memory operations. In response to detecting/receiving a command to perform a standard memory operation, standard memory operation module 308 may identify the type of standard memory operation to be performed and initiate the appropriate standard memory operation.

Perform active memory operation module 310 may perform an active memory operation during time allocated for a standard memory operation. In some implementations, perform active memory operation module 310 may monitor progress of a standard memory operation during time allocated for the standard memory operation. If the allocated time is not up when the standard memory operation has been completed, perform active memory operation module 310 may perform an active memory operation. In some implementations, perform active memory operation module 310 may perform an active memory operation instead of a standard memory operation during time allocated for the standard memory operation. For example, when memory controller 320 issues a refresh command, perform active memory operation module 310 may perform an active memory operation at the beginning of the time allocated for the refresh cycle if, at the time the refresh command is issued, a timing specification of volatile memory 302 does not require a refresh command to be performed. Situations in which a refresh command may not be executed are discussed above with respect to FIG. 2.

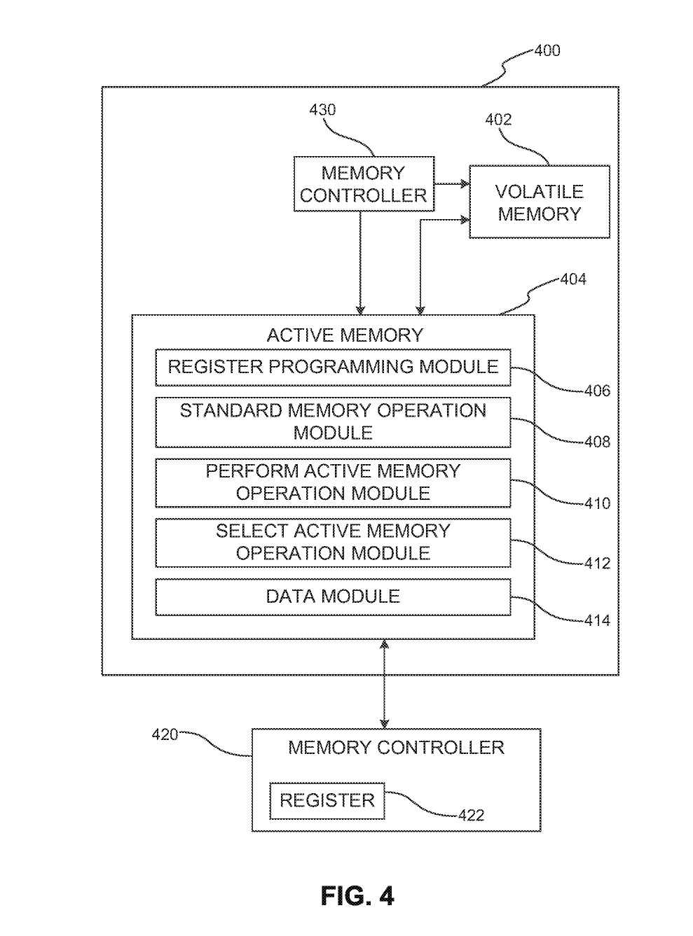

FIG. 4 is a block diagram of an example memory module 400 in communication with an example memory controller 420 to enable selection of active memory operations and control over access to data in a volatile memory. Memory module 400 may be an in-line memory module, such as a SIMM or DIMM, or any memory module suitable for mounting volatile memory ICs. In FIG. 4, memory module 400 includes volatile memory 402, active memory 404, and memory controller 430.

Volatile memory 402 may be analogous to volatile memory 302. A timing specification of volatile memory 402 may specify how much time is required to perform standard memory operations on volatile memory 402. A command to perform a standard memory operation may be transmitted to memory module 400 from memory controller 420, which may include register 422. Memory controller 420 and register 422 may be analogous to memory controller 320 and register 322, respectively. Memory controller 420 may be communicatively coupled to memory module 400 via a data bus. The data bus type and/or speed may correspond to a memory type/operating speed of volatile memory 402.

It should be understood that memory controller 420 may have more registers in addition to register 422, and that the additional registers may be associated with the same standard memory operation as or different standard memory operations than that associated with register 422. In some implementations, volatile memory 402 may include multiple memory types: the additional registers may be used to determine a time allocated for a standard memory operation for the same memory type or a different memory type as that for which the value in register 422 is used. The amount of time allocated for a standard memory operation may be greater than the amount of time that a timing specification of volatile memory 402 requires for the standard memory operation. During the extra time, active memory 404 may perform an active memory operation.

Active memory 404 may be communicatively coupled to volatile memory 402 and memory controller 430 on memory module 400, and to memory controller 420. Memory controller 430 may be an internal memory controller on memory module 400, and may be a digital circuit that controls access by active memory 404 and other components within memory module 400 to volatile memory 402. Memory controller 430 may manage the flow of data between volatile memory 402 and other components within memory module 400 (e.g., active memory 404). Memory controller 430 may be operated at a frequency higher than the frequency at which memory controller 420 is operated, and/or higher than a frequency based on which memory controller 420 allocates time for standard memory operations. Although memory controller 430 is shown separately from active memory 404 in FIG. 4, it should be understood that in some implementations, memory controller 430 may be integrated into active memory 404.

Active memory 404 may include a processor-in-memory, FPGA, and/or logic core, and may be tightly coupled to volatile memory 402. Active memory 404 may include a buffer for storing data read from volatile memory 402, and may process the data in the buffer while standard memory operations are performed on volatile memory 402. As illustrated in FIG. 4 and described in detail below, active memory 404 may include modules 406, 408, 410, 412, and 414. A module may include a set of instructions encoded on a machine-readable storage medium and executable by a processor of active memory 404. In addition or as an alternative, a module may include a hardware device comprising electronic circuitry for implementing the functionality described below.

Modules 406, 408, and 410 of active memory 404 may be analogous to modules 306, 308, and 310 of active memory 304. In some implementations, standard memory operation module 408 may determine a length of time needed to perform a standard memory operation. The length of time may be determined based on operation of volatile memory 402 at a second frequency higher than a first frequency based on which memory controller 420 allocates time for the standard memory operation. Select active memory operation module 412 may select an active memory operation to be performed during the allocated time for the standard memory operation. The selection may be made based on a difference between the allocated time for the standard memory operation and the determined length of time needed to perform the standard memory operation.

Data module 414 may read data from volatile memory 402. The data may be read into a buffer of active memory 404. Perform active memory operation module 410 may perform an active memory operation using the data read from volatile memory 402. In some implementations, memory module 400 may include a non-volatile memory, and data module 414 may transfer data between volatile memory 402 and the non-volatile memory. For example, data module 414 may read data from the non-volatile memory into a buffer on active memory 404, and may write the data in the buffer to volatile memory 402. In some implementations, data module 414 may transmit data read from volatile memory 402 and/or the non-volatile memory to memory controller 420 or to another component external to memory module 200.

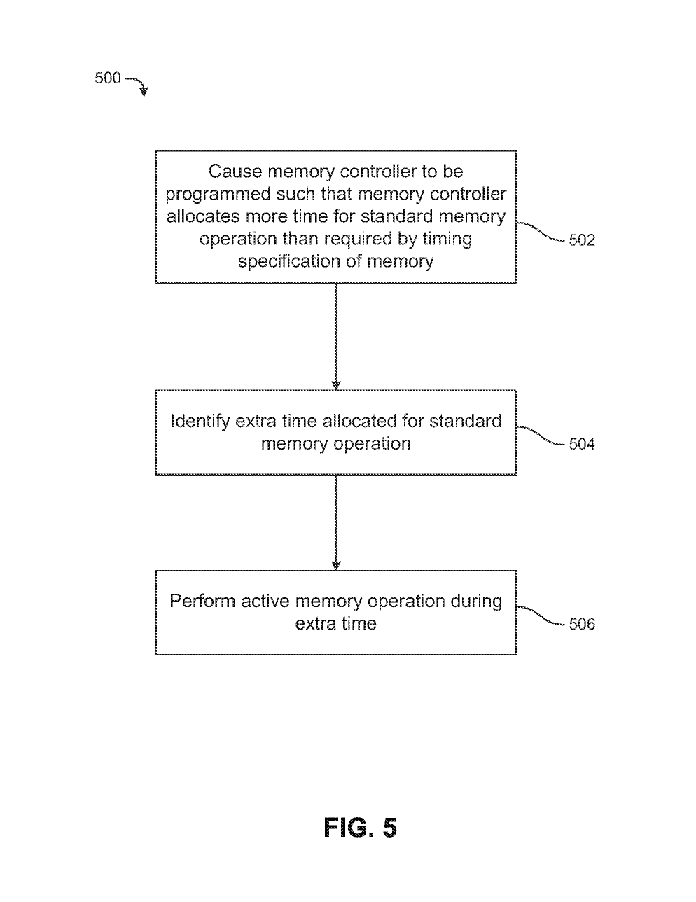

Methods related to enabling performance of active memory operations are discussed with respect to FIGS. 5-9. FIG. 5 is a flowchart of an example method 500 for performing active memory operations. Although execution of method 500 is described below with reference to active memory 104 of FIG. 1, it should be understood that execution of method 500 may be performed by other suitable devices, such as active memory 204. Method 500 may be implemented in the form of executable instructions stored on a machine-readable storage medium and/or in the form of electronic circuitry.

Method 500 may start in block 502, where active memory 104 may cause a memory controller to be programmed such that the memory controller allocates more time for a standard memory operation than required by a timing specification of a memory. The memory controller may be communicatively coupled to the memory, for example directly or via active memory 104. The memory may be a volatile memory, such as volatile memory 102.

Next, in block 504, active memory 104 may identify extra time allocated for the standard memory operation. For example, active memory 104 may detect a command transmitted by a memory controller to perform a standard memory operation on a memory, determine how much time the memory controller has allocated for the standard memory operation, and monitor progress in performing the standard memory operation. Active memory 104 may identify extra time as time that is allocated for the standard memory operation and that remains after the standard memory operation is completed.

Finally, in block 506, active memory 104 may perform an active memory operation during the extra time. An active memory operation may include filtering, compressing, and/or transferring data.

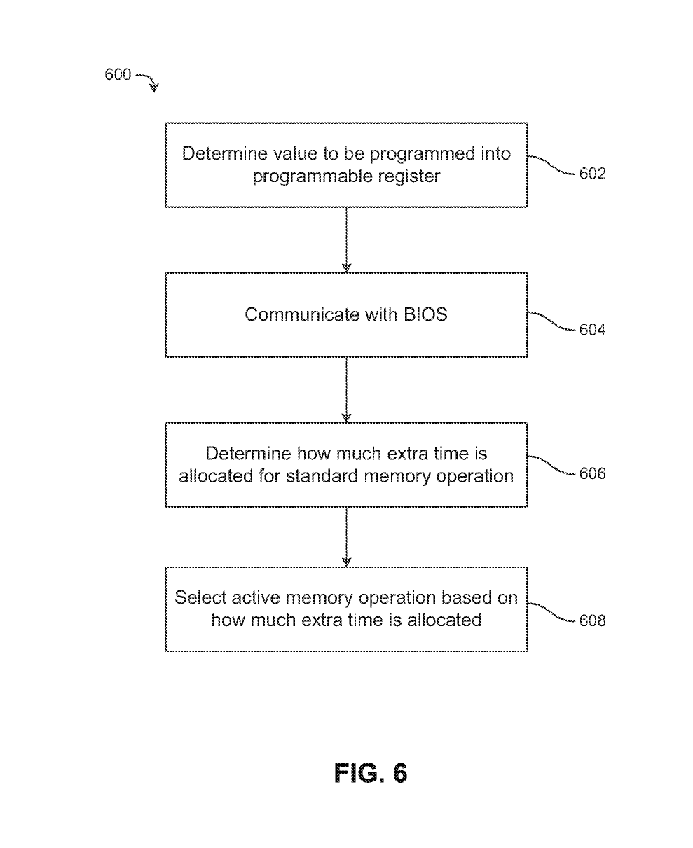

FIG. 6 is a flowchart of an example method 600 for programming registers to allow active memory operations to be performed and selecting active memory operations. Although execution of method 600 is described below with reference to active memory 204 of FIG. 2, it should be understood that execution of method 600 may be performed by other suitable devices, such as active memory 104. Method 600 may be implemented in the form of executable instructions stored on a machine-readable storage medium and/or in the form of electronic circuitry.

Method 600 may start in block 602, where active memory 204 may determine a value to be programmed into a programmable register. For example, the value in the programmable register may correspond to how many clock cycles are allocated for a refresh cycle on a volatile memory, and a timing specification of the volatile memory may specify a length of time required for a refresh cycle to be completed. Active memory 204 may calculate, based on an operating frequency of a memory controller communicatively coupled to the volatile memory, how many clock cycles occur during the specified length of time. Active memory 204 may select a value greater than the calculated number of clock cycles to be programmed into the programmable register.

In block 604, active memory 204 may communicate with a BIOS. Active memory 204 may transmit the value determined in block 602 to the BIOS, which may program the value into a register of a memory controller. Communication with a BIOS is discussed above with respect to FIG. 1.

In block 606, active memory 204 may determine how much extra time is allocated for a standard memory operation. For example, active memory 204 may identify a standard memory operation to be performed on a memory and determine how long a timing specification of the memory requires for the identified standard memory operation. Active memory 204 may determine how much time a memory controller communicatively coupled to the memory has allocated for the standard memory operation (e.g., by reading a value stored in a register of the memory controller), and may subtract the required time from the allocated time to determine how much extra time is allocated for the standard memory operation.

Finally, in block 608, active memory 204 may select an active memory operation based on how much extra time is allocated. Active memory 204 may determine how long each of a plurality of active memory operations take to complete, and may select one of the plurality of active memory operations that takes less time than the amount of extra time allocated.

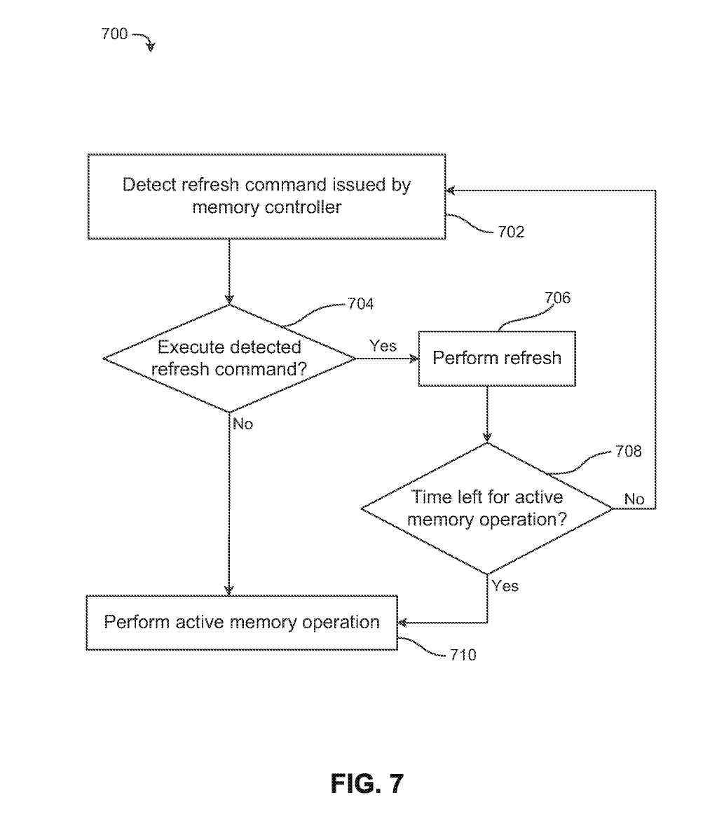

FIG. 7 is a flowchart of an example method 700 for determining when an active memory operation should be performed. Although execution of method 700 is described below with reference to active memory 204 of FIG. 2, it should be understood that execution of method 700 may be performed by other suitable devices, such as active memory 104. Method 700 may be implemented in the form of executable instructions stored on a machine-readable storage medium and/or in the form of electronic circuitry.

Method 700 may start in block 702, where active memory 204 may detect a refresh command issued by a memory controller. The memory controller may issue the refresh command to refresh a group of data bits in a volatile memory communicatively coupled to active memory 204 and to the memory controller. Active memory 204 and the volatile memory may be on respective ICs mounted on the same in-line memory module (e.g., memory module 200), and the memory controller may be external to the in-line memory module.

In block 704, active memory 204 may determine whether the detected refresh command should be executed. For example, active memory 204 may determine how long ago the last refresh cycle was completed on the group of data bits targeted by the refresh command. If the determined time is less than the maximum time between refresh cycles required by a timing specification of the volatile memory, active memory 204 may determine that the detected refresh command should not be executed. When active memory 204 determines that the detected refresh command should not be executed, method 700 may proceed to block 710, in which active memory 204 may perform an active memory operation.

When active memory 204 determines that the detected refresh command should be executed, method 700 may proceed to block 706, in which active memory 204 may perform a refresh operation on the volatile memory. Method 700 may then proceed to block 708, in which active memory 204 may determine whether there is enough time left after the refresh operation to perform an active memory operation. When active memory 204 determines that there is not enough time left to perform an active memory operation, method 700 may loop back to block 702. When active memory 204 determines that there is enough time left to perform an active memory operation, method 700 may proceed to block 710. In some implementations, active memory 204 may select an active memory operation to be performed in block 710 based on how much time is left after the refresh operation is completed.

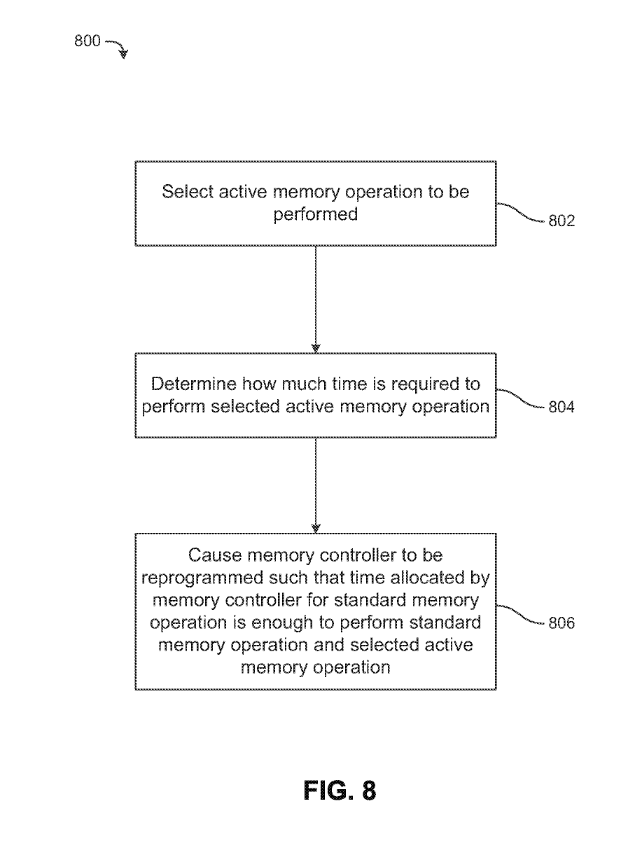

FIG. 8 is a flowchart of an example method 800 for allowing a selected active memory operation to be performed. Although execution of method 800 is described below with reference to active memory 304 of FIG. 3, it should be understood that execution of method 800 may be performed by other suitable devices, such as active memory 404. Method 800 may be implemented in the form of executable instructions stored on a machine-readable storage medium and/or in the form of electronic circuitry.

Method 800 may start in block 802, where active memory 304 may select an active memory operation to be performed. In some implementations, an active memory operation may be selected based on the type and/or quantity of data in a buffer of active memory 304. For example, if the buffer is almost full, a data compression operation may be selected.

Next, in block 804, active memory 304 may determine how much time is required to perform the selected active memory operation. For example, active memory 304 may determine how many clock cycles it takes to perform the selected active memory operation. In some implementations, active memory 304 may convert, based on an operating frequency of active memory 304, a number of clock cycles to a length of time.

Finally, in block 806, active memory 304 may cause a memory controller to be reprogrammed such that time allocated by the memory controller for a standard memory operation is enough to perform the standard memory operation and the selected active memory operation. In some implementations, active memory 304 may determine values to be programmed into registers of the memory controller. To cause the memory controller to be reprogrammed, active memory 304 may communicate with a BIOS, as discussed above with respect to FIG. 1.

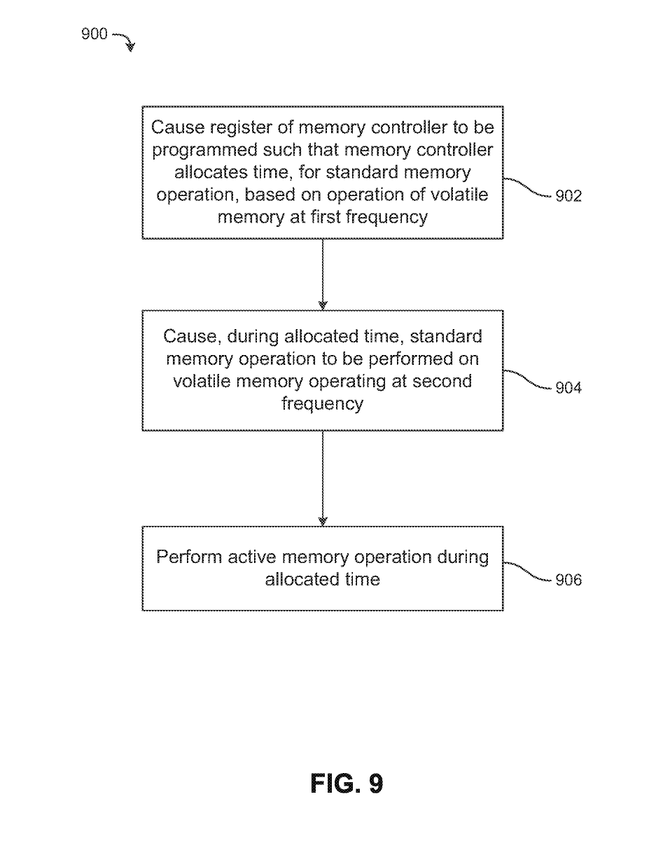

FIG. 9 is a flowchart of an example method 900 for allocating time to perform active memory operations. Although execution of method 900 is described below with reference to active memory 304 of FIG. 3, it should be understood that execution of method 900 may be performed by other suitable devices, such as active memory 404. Method 900 may be implemented in the form of executable instructions stored on a machine-readable storage medium and/or in the form of electronic circuitry.

Method 900 may start in block 902, where active memory 304 may cause a register of a memory controller to be programmed such that the memory controller allocates time, for a standard memory operation, based on operation of a volatile memory at a first frequency. Active memory 304 may be communicatively coupled to the volatile memory and to the memory controller. Active memory 304 and the volatile memory may be on respective ICs mounted on the same in-line memory module (e.g., memory module 300), and the memory controller may be external to the in-line memory module.

Next, in block 904, active memory 304 may cause, during the allocated time, the standard memory operation to be performed on the volatile memory while the volatile memory is operating at a second frequency different from the first frequency. The second frequency may he higher than the first frequency. Active memory 304 may detect and/or receive, from the memory controller, commands to perform standard memory operations. In response to detecting/receiving a command to perform a standard memory operation, active memory 304 may identify the type of standard memory operation to be performed and initiate the appropriate standard memory operation.

Finally, in block 906, active memory 304 may perform an active memory operation during the time allocated for the standard memory operation. In some implementations, active memory 304 may monitor progress of the standard memory operation during time allocated for the standard memory operation. Active memory 304 may perform an active memory operation when the standard memory operation has been completed.

The foregoing disclosure describes active memories that may perform active memory operations, and interactions of such active memories with volatile memories and memory controllers. Example implementations described herein enable programming of memory controllers to allow active memory operations to be performed and determining circumstances under which active memory operations may be performed.

We claim:

1. A method for performing active memory operations, the method comprising:
causing a memory controller to be programmed such that the memory controller allocates more time for a standard memory operation than required by a timing specification of a first memory, wherein the memory controller is communicatively coupled to the first memory;
identifying extra time allocated for the standard memory operation; and
performing an active memory operation during the extra time.

2. The method of claim 1, wherein the memory controller comprises a programmable register associated with a time allocated for the standard memory operation, the method further comprising determining a value to be programmed into the programmable register.

3. The method of claim 1, wherein identifying extra time comprises:
detecting a refresh command issued by the memory controller; and
determining whether to execute the detected refresh command.

4. The method of claim 1, further comprising:
determining how much extra time is allocated for the standard memory operation; and
selecting the active memory operation based on how much extra time is allocated.

5. The method of claim 1, further comprising:
selecting the active memory operation to be performed;
determining how much time is required to perform the selected active memory operation; and
causing the memory controller to be reprogrammed such that the time allocated by the memory controller for the standard memory operation is enough to perform the standard memory operation and the selected active memory operation.

6. The method of claim 1, wherein causing the memory controller to be programmed comprises communicating with a Basic Input/Output System (BIOS).

7. A system for performing active memory operations, the system comprising:
a volatile memory, wherein data stored in the volatile memory is periodically refreshed; and
an active memory communicatively coupled to the volatile memory and to a first memory controller, wherein the active memory is to:
cause a register of the first memory controller to be programmed such that the first memory controller allocates more time for refreshing the volatile memory than required by a timing specification of the volatile memory;
identify extra time allocated for refreshing the volatile memory; and
perform an active memory operation during the extra time.

8. The system of claim 7, further comprising:
a non-volatile memory communicatively coupled to the active memory; and
a second memory controller to control access to the volatile memory and the non-volatile memory by the active memory.

9. The system of claim 8, wherein the active memory is further to transfer data between the volatile memory and the non-volatile memory.

10. The system of claim 7, wherein the active memory is further to read data from the volatile memory, and wherein the active memory operation is performed using the data read from the volatile memory.

11. The system of claim 7, wherein the active memory is further to:
detect a refresh command issued by the first memory controller; and
determine whether to execute the detected refresh command, wherein the active memory operation is performed if the detected refresh command is not executed.

12. The system of claim 7, wherein the active memory is further to:
determine how much extra time is allocated for refreshing the volatile memory; and
select the active memory operation based on how much extra time is allocated.

13. A system for performing active memory operations, the system comprising:
a volatile memory;
an active memory communicatively coupled to the volatile memory and to a first memory controller, wherein the active memory is to:
cause a register of the first memory controller to be programmed such that the first memory controller allocates time, for a standard memory operation, based on operation of the volatile memory at a first frequency;
cause, during the allocated time, the standard memory operation to be performed on the volatile memory, wherein the volatile memory is operated at a second frequency higher than the first frequency during the allocated time; and
perform an active memory operation during the allocated time.

14. The system of claim 13, wherein the active memory is further to:
determine a length of time needed to perform the standard memory operation, wherein the length of time is determined based on operation of the volatile memory at the second frequency; and
select the active memory operation based on a difference between the allocated time and the determined length of time.

15. The system of claim 13, further comprising a second memory controller communicatively coupled to the volatile memory, wherein:
the second memory controller controls access to the volatile memory by the active memory;
the second memory controller is operated at the second frequency;
the active memory is further to read data from the volatile memory; and
the active memory operation is performed using the data read from the volatile memory.
